(19) United States
(12) Patent Application Publication
(10) Pub. No.: US 2013/0058643 A1
(43) Pub. Date: Mar. 7, 2013

(54) DATA AMOUNT DERIVATION APPARATUS

(71) Applicants: Hiroyuki HONMA, Kawasaki (JP); Toru Katagiri, Kawasaki (JP); Hiromichi Makishima, Kawasaki (JP); Masahiro Shioda, Kawasaki (JP); Hiroyuki Kitajima, Oyama (JP); Ichiro Yokokura, Sano (JP)

(72) Inventors: Hiroyuki HONMA, Kawasaki (JP); Toru Katagiri, Kawasaki (JP); Hiromichi Makishima, Kawasaki (JP); Masahiro Shioda, Kawasaki (JP); Hiroyuki Kitajima, Oyama (JP); Ichiro Yokokura, Sano (JP)

(73) Assignee: FUJITSU LIMITED, Kawasaki-shi (JP)

(21) Appl. No.: 13/665,146

(22) Filed: Oct. 31, 2012

Related U.S. Application Data
(63) Continuation of application No. PCT/JP2010/057718, filed on Apr. 30, 2010.

(51) Int. Cl. H04B 10/08

(52) U.S. Cl. 398/25

(57) ABSTRACT

A data amount derivation apparatus includes: a first calculator configured to derive, for one series of parallelized mapping signals, amount of data in each frame period for a frame into which the parallelized mapping signals are mapped; and a second calculator configured to sum up amounts of data in N frame periods, where N is an integer, and to derive the resulting summation value as the amount of data to be mapped into the frame, each of the amounts of data in each of the frame periods being derived by the first calculator.

### CROSS-REFERENCE TO RELATED APPLICATION

This application is based upon and claims the benefit of priority of the International Patent Application No. PCT/JP2010/057718, filed on Apr. 30, 2010, the entire contents of which are incorporated herein by reference.

### FIELD

The disclosure relates to a data amount derivation apparatus.

### BACKGROUND

OTN (Optical Transport Network) specified in ITU-T recommendation G.709 is one of the standards for optical transport networks. In OTN, client signals such as SDH (Synchronous Digital Hierarchy) and Ethernet (registered trademark) frames are transferred in OPU (Optical channel Payload Unit) frames, ODU (Optical channel Data Unit) frames, OTU (Optical channel Transport Unit) frames, or ODTU (Optical channel Data Tributary Unit) frames.

As illustrated in FIG. 11, an OPU frame is structured by containing a client signal in a payload area and adding an OPU overhead (OPU-OH) to the payload area. An ODU frame is structured by containing an OPU frame in the payload area and adding an ODU overhead to the payload area. An OTU frame is structured by containing an ODU frame in the payload area and adding an OTU overhead and an FEC (Forward Error Correction) code to the payload area.

FIG. 12 illustrates a format of the OTU frame. The OTU frame has an OH for connection and quality control. The OH contains frame alignment bytes (FAS), OTU-OH, ODU-OH, and OPU-OH. The OTU frame is structured as 4 rows by 4080 columns. In actual transmission of the OTU frame, the OTU frame is transmitted in sequence, starting from the first row at the top of the frame.

Each of the OTU frame, the ODU frame, and the OPU frame has a plurality of types according to transmission rates. For example, the OTU frame has the following types: OTU1 corresponding to SDH STM-16 (the bit rate of OTU1 is 255/238×2.48832 Gbit/s), OTU2 corresponding to STM-64 (the bit rate of OTU2 is 255/237×9.953280 Gbit/s), and OTU3 corresponding to STM-256 (the bit rate of OTU3 is 255/236×39.813120 Gbit/s). In addition, OTU4 corresponding to 100 GbE (100 Gigabit Ethernet (Ethernet is a registered trademark) has been defined (the bit rate of OTU4 is 255/227×99.532800 Gbit/s).

An asynchronous mapping method called the GMP (Generic Mapping Procedure) is currently under study, which is a technique to map a client signal having any bit rate less than or equal to the bit rate of the payload area of an OPU frame into the frame.

GMP is a method for mapping a client signal of any of various types of client signals into the payload area of OPUk (k is an order number) while performing byte-by-byte stuffing to accommodate the bit-rate difference between the client signal and the server frame. FIG. 13 illustrates GMP into an OPUk frame. As illustrated in FIG. 13, control parameters for GMP are contained in part of the OH area of the OPUk frame. The control parameters include the amount of stuff (data) contained in the payload area and timing information for the data. In the GMP, data and stuff are mapped in such a manner that stuff (S) is substantially uniformly distributed in the payload area. Two types of GMP mapping mode are defined. In a first type, a client signal (CBR) is contained in an LO (Lower Order) OPU frame; in a second type, an LO ODUj (j is an order number) frame is mapped into multiple HO (Higher Order) OPUk (k is an order number) frames by way of an ODTU frame.

FIG. 14 is a diagram illustrating the first and second types of mapping methods. The first type of mapping method is depicted in the upper part of FIG. 14. The second type of mapping method is depicted in the lower part of FIG. 14.

In the first type, a client signal such as a GbE signal is mapped into the payload area of an LO OPU frame whereas control information concerning the mapping (such as GMP parameters) is contained in the OH area. FIG. 13 illustrates an LO OPU frame into which a client signal has been mapped according to the first type.

In the second type, one or more client signals (LO ODUj frames) are mapped into the payload area of an ODTU frame. The ODTU frame is made up of ODTU payload areas and ODTU OH areas. The ODTU payload areas are structured by dividing the payload area of an HO OPUk frame into a number M of TSs (tributary slots), each of which is a one byte in length, and combining the sub-areas that have the same TS number across M HO OPUk frames. The ODTU OH areas are OH areas of HO OPUk frames that have a multi-frame number corresponding to the TS number among the M number of HO OPUk frames.

In the example illustrated in FIG. 14, LO ODUj1, which is client signal #1, is mapped into an ODTU frame payload area TS #1 (an area having TS number #1 of each HO OPUk frame). OH of the ODPU frame corresponding to client signal #1 (ODTU (#1) OH) is mapped into the OH area of an HO OPUk (#1) frame. LO ODUj2, which is client signal #2, is mapped into TS #2 of the ODTU frame payload area (the area having TS number #2 of each HO OPUk frame) and TS #Mmax (the area having TS number #Mmax of each HO OPUk frame). OH (ODTU (#1) OH and ODTU (#Mmax) OH) of the ODPU frames (#2 and #Mmax) corresponding to client signal #2 are mapped into the OH areas of an HO OPUk (#2) frame and HO OPUk (#Mmax) frame, respectively. By mapping multiple client signals (LO OPUj frames) into ODTU frames in this way, the client signals can be multiplexed in multiple HO OPUk frames and transmitted.

While TSs with the same TS number are collectively depicted as existing in the payload area of each HO OPUk frame in FIG. 14, TS areas having the same TS number are distributed in actual HO OPUk frames.

For more information, see the U.S. Pat. No. 7,020,094.

To implement GMP, GMP parameters (control parameters) known as “Cₙ”, “Cₘ” and “C_{nD}” are derived. GMP parameter Cₙ is a logical value of the amount of data of a client signal to be carried in the payload area of an OPU frame or an ODTU frame for containing a client signal (these frames will be hereinafter referred to as the server frames). The logical value Cₙ can be obtained on the basis of the difference between the frequency of the client signal and the frequency of the server frame. The logical value Cₙ is the amount of data of the client signal contained, represented in n bits.

GMP parameter Cₘ is a logical value representation in M bytes (m=8×M) of the logical value Cₙ and indicates the amount of data actually carried in the server frame at an M-byte granularity (m=8×M).

GMP parameter C_{nD} is information indicating the difference between the logical values Cₙ and Cₘ. The amount of data to be transmitted is represented in n bits whereas m bits (m/8 bytes) of data are actually transmitted in the server frame. C_{nD} represents the difference between Cₙ and Cₘ in n bits.

The logical value Cₙ is a value equivalent to frequency information of a mapped signal (client signal).

### SUMMARY

An embodiment of the present invention is a data amount derivation apparatus including:

a first calculator configured to derive, for one series of parallelized mapping signals, amount of data in each frame period for a frame into which the parallelized mapping signals are mapped; and

a second calculator configured to sum up amounts of data in N frame periods, where N is an integer, and to derive the resulting summation value as the amount of data to be mapped into the frame, each of the amounts of data in each of the frame periods being derived by the first calculator.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a configuration for deriving a logical value Cₙ.

FIG. 2 illustrates equations for calculating Cₙ.

FIG. 3 illustrates equations for calculating the real number and integer of Cₘ and the real number and integer of C_{nD}.

FIG. 4 schematically illustrates an exemplary configuration of a data amount derivation apparatus (GMP parameter derivation apparatus) according to a first embodiment of the present invention.

FIG. 5 illustrates changes in GMP parameters with time when the number of additions (the number of summations) is 3.

FIG. 6 is a diagram illustrating an operation relating to a configuration of the first embodiment.

FIG. 7 is a diagram illustrating an exemplary configuration of a data amount derivation apparatus according to a second embodiment.

FIG. 8 illustrates an exemplary configuration of a GMP mapping apparatus (frame generation apparatus) mapping a client signal into a server frame.

FIG. 9 is a diagram illustrating a variation of a third embodiment.

FIG. 10 is a diagram illustrating a multi-frame method.

FIG. 11 is a diagram illustrating frames of OTN.

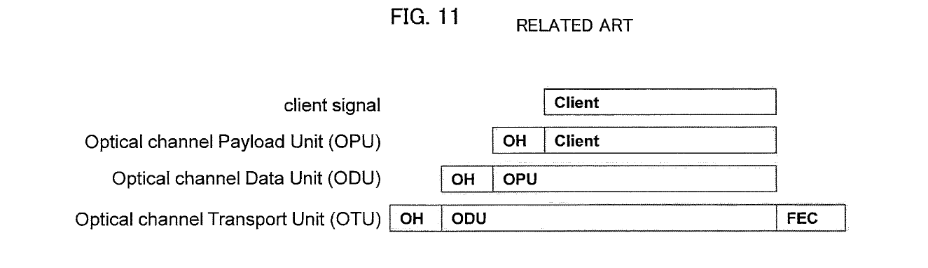

FIG. 12 illustrates a format of an OTU frame.

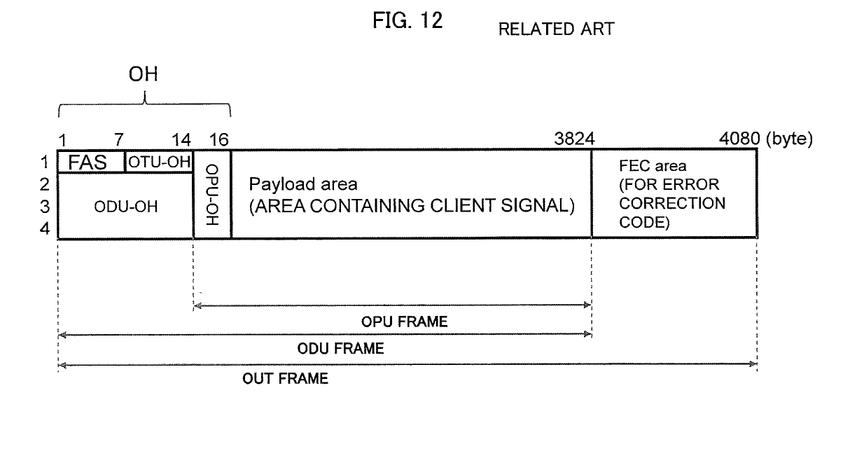

FIG. 13 is a diagram illustrating GMP.

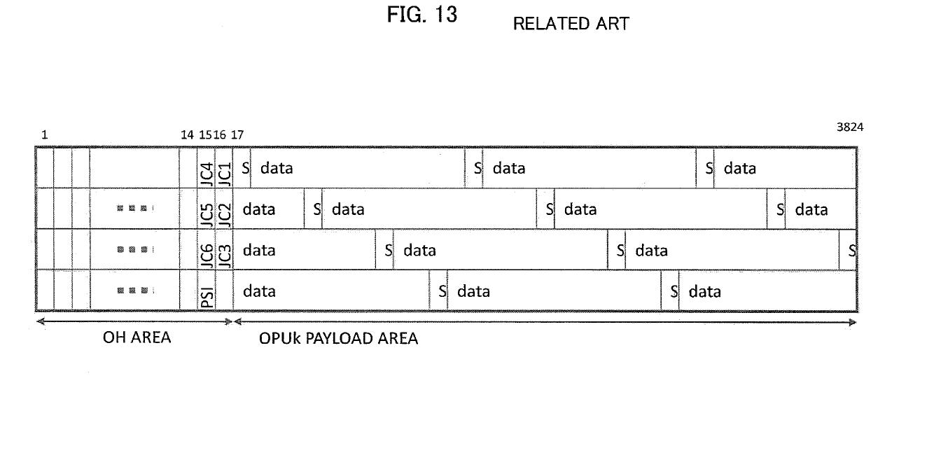

FIG. 14 is a diagram illustrating GMP mapping methods of first and second types.

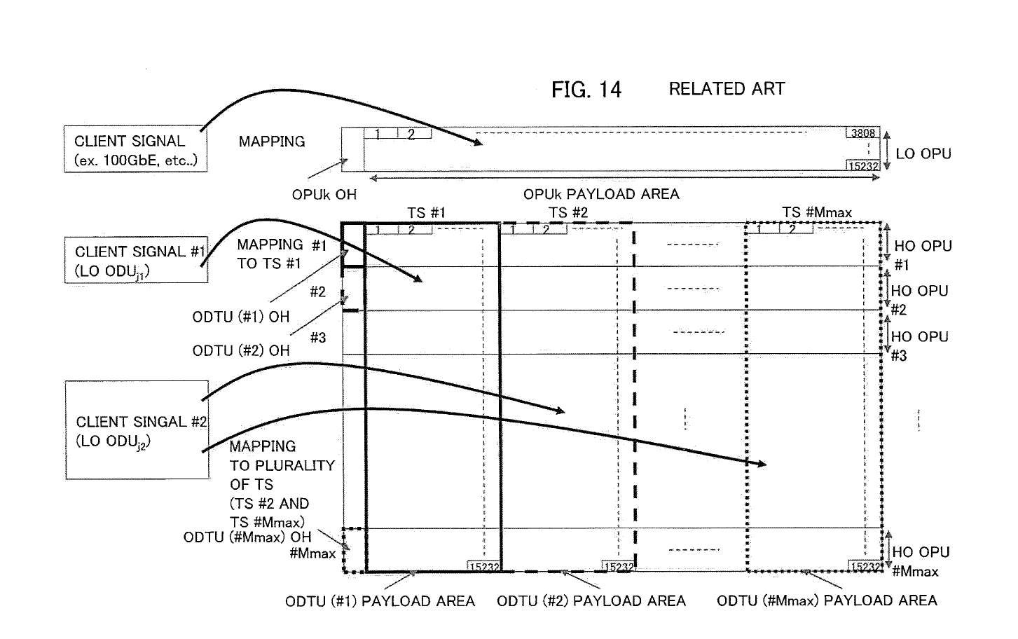

### DESCRIPTION OF THE EMBODIMENT

Embodiments of the present invention will be described below with reference to drawings. The description of the embodiments is illustrative only and the present invention is not limited to configurations of the embodiments.

### First Embodiment

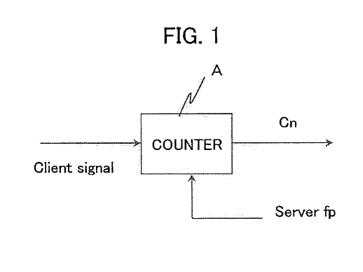

A data amount derivation apparatus according to a first embodiment will be described. GMP parameters, Cₙ, C_{m′}, Cₘ, and ΣC_{nD}, used in GMP will be described first. FIG. 1 is a diagram schematically illustrating a configuration for deriving Cₙ.

A client signal in OTN is contained in a server frame, is converted to an optical signal and transmitted. When being contained in the frame, the client signal is mapped into the payload area of the frame.

A client signal to be mapped into a server frame is input into a counter A in FIG. 1. Also, a signal (fp) indicating a frame period of the server frame is input into the counter A. The counter A counts the amount of data of the client signal input in a frame period in n bits as a unit and outputs the data amount as Cₙ.

In this way, Cₙ can be obtained by counting the client signal received in a server frame period in n bits as unit. Here, n represents the number of bits. If n=1, it means that the client signal is counted bit by bit. Note that the value of n of Cₙ can be determined for each client (each client signal format).

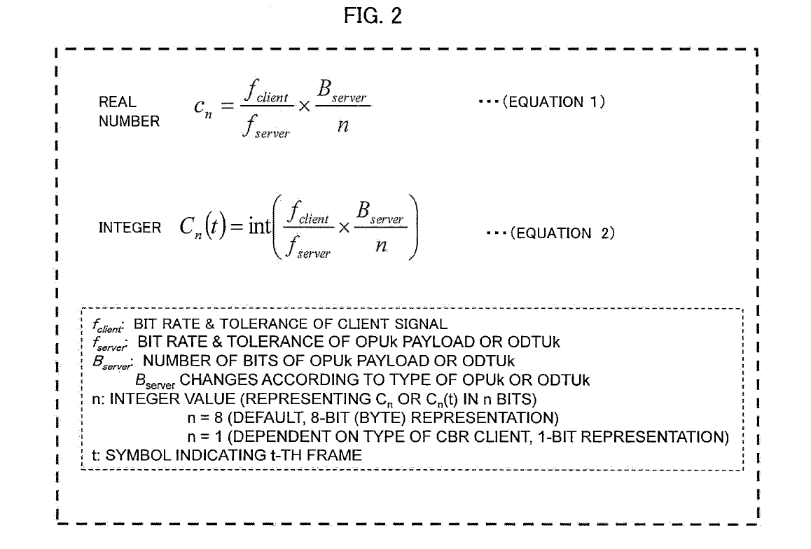

For example, if the client is OC48, the period of the server frame is 1 second, and their frequency deviation is 0, Cₙ is C₁=2488320 when n=1, and C₈=311040 when n=8. Mathematically, Cₙ can be calculated according to Equations 1 and 2 in FIG. 2. The range of the integer Cₙ (t) of Cₙ applies only when the server frame frequency is higher than the client signal frequency.

Cₘ is a value of Cₙ represented with an M-byte granularity (m=8×M). Here, M indicates that a client signal is contained in a server frame in M bytes as a unit and can be determined for each client. For example, if the client is 1 GbE, M=1; if the client is OC48, M=2; and if the client is 100 GbE, M=80. For example, if the client is OC48, n=8, M=2, the server frame period is 1 second, and the frequency deviation is 0, then Cₘ is Cₘ=C₈ (=311040)/M(=2)=155520 [bytes].

To actually calculate Cₘ, Cₙ is divided by M and the fractional part of the result is discarded to obtain C_{m′}. That is, C_{m′} can be expressed as Equation 3 given below.

C_{m′}=Int(Cₙ/M) (Equation 3)

Since C_{m′} given above is equal to the value of Cₘ truncated to an integer, there is difference between Cₙ and C_{m′}×M. The difference is C_{nD}, which can be expressed as Equation 4 given below.

C_{nD}=mod(Cₙ/M) (Equation 4)

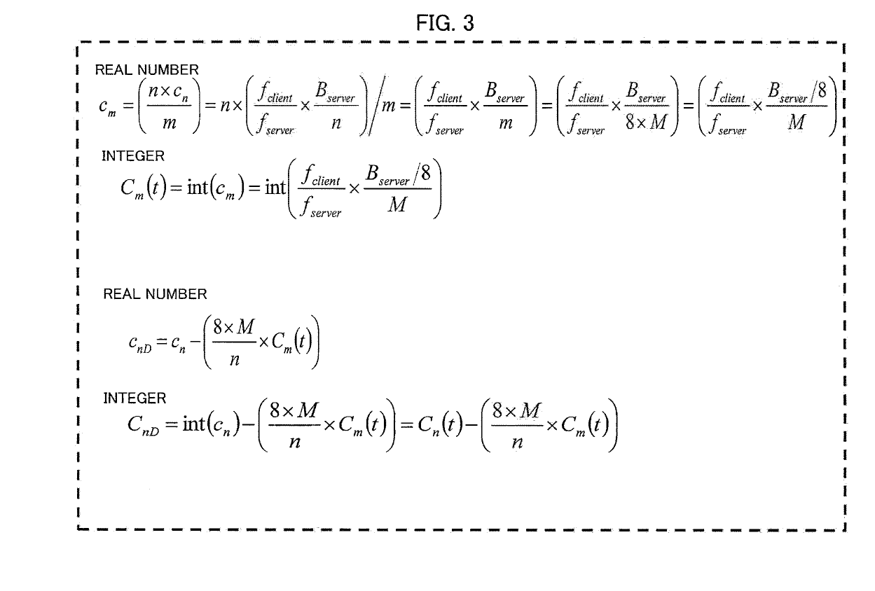

For example, if Cₙ=101 and M=2, then C_{nD}=1. FIG. 3 illustrates equations for deriving the real number and integer of Cₘ and the real number and integer of C_{nD}.

ΣC_{nD} is the sum of a set of C_{nD} each derived in each server frame period. When the value of ΣC_{nD} becomes greater than or equal to M, M is subtracted from the value of ΣC_{nD}. When ΣC_{nD} is greater than or equal to M, it means that the cumulative value of differences C_{nD} has increased to C_{m′}+1. If that is the case, the value of Cₘ in that frame period is C_{m′}+1; otherwise C_{m′} obtained in the period is used.

When a client signal is mapped into a server frame, whether to map the client signal or stuff is determined on the basis of the value of Cₘ. The values of Cₘ and ΣC_{nD} are contained in the overhead (OH) of the server frame as control data for performing demapping at the server frame receiving end.

Cₙ is a logical value of the amount of data, which can be obtained on the basis of the difference between the frequency of a client signal and the frequency of a server frame as shown in Equations 1 and 2. Since Cₘ and ΣC_{nD} can be determined on the basis of the value of Cₙ, the accuracy of demapping at the demapping end depends on the value of Cₙ.

To derive Cₙ, measurement is performed in bits if n=1 or in bytes if n=8. If measurement is performed in bits, Cₙ can be measured by directly measuring a client signal which is a serial signal. When measurement is performed in bytes, Cₙ can be obtained by measuring 8 parallel client signals converted from a serial signal, or measuring a serial signal in bits, and dividing the measured value by 8.

In the case of a low-rate signal such as OC3 and 1 GbE, Cₙ can be accurately calculated by directly measuring the client signal. Oₙ the other hand, in the case of a high-rate signal such as 100 GbE, it is difficult to directly measure Cₙ because signal processing cannot keep pace with the speed of the signal. To address this, the first embodiment uses the following configuration in order to obtain more accurate Cₙ.

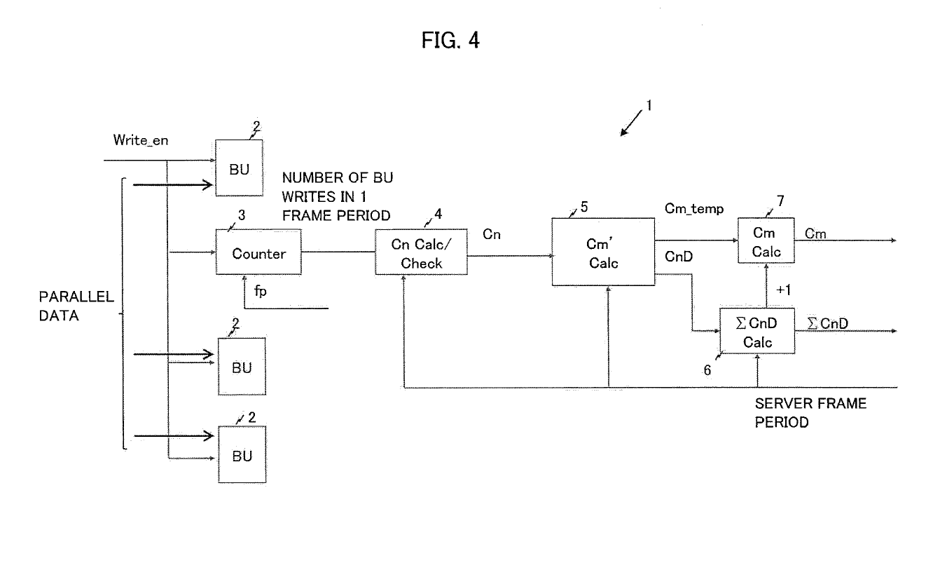

FIG. 4 schematically illustrates an exemplary configuration of a data amount derivation apparatus (GMP parameter derivation apparatus) according to the first embodiment of the present invention. The data amount derivation apparatus 1 in FIG. 4 includes a plurality of buffers 2, a counter 3, a Cₙ calculation unit (Cₙ calculator: Cₙ Calc/check) 4, a C_{m′} calculation unit (C_{m′} calcurator: C_{m′} Calc) 5, and a ΣC_{nD} calculation unit (ΣC_{nD} calculator: ΣC_{nD} Calc) 6.

Parallel data series produced by parallelizing serial data equivalent to a client signal in accordance with a predetermined M-byte granularity are temporality stored in the plurality of buffers 2. The buffers 2 are used for placing a client signal into the payload area of a server frame. In the example illustrated in FIG. 4, M=3 and the three parallel data series are stored in three buffers 2. An equal amount of data is stored in the buffers 2.

A signal (fp) indicating a frame period of the server frame into which serial data is to be contained (mapped) is input in the counter 3. In the example illustrated in FIG. 4, a write enable signal (Write_en) which is input in each of the buffers is input into the counter 3. The write enable signal is the parallelized client signal described above. The counter 3 counts the number of write enable signals appearing in one server frame period (the number of BU writes in one frame period) and provides the number of BU writes in each frame period to the Cₙ calculation unit 4. The counter 3 may count the number of write clock signals instead of write enable signals.

The Cn calculation unit 4 obtains the value of Cₙ. For example, the Cn calculation unit obtains the amount of data in each frame period from the number of BU writes. The amount of data for one write enable signal is fixed and the Cn calculation unit 4 can derive the amount of data written in the buffers 2 from the number of enable signals. Alternatively, if the number of write clock signals is input, the Cₙ calculation unit 4 can obtains the amount of data in a frame period from the number of write clock signals on the basis of the amount of data per write clock signal. Here, the amount of data in each frame obtained represents the amount of data of one series of parallel data, which is a client signal parallelized with an M-byte granularity (M=3).

The Cₙ calculation unit 4 adds the amounts of data in each frame in M cycles or in a predetermined number N of cycles that is a function of M to obtain a cumulative value (summation value) as Cₙ (Cₙ(t)). The Cₙ calculation unit 4 checks to see whether Cₙ falls within a valid range and provides the obtained Cₙ to the C_{m′} calculation unit 5.

The C_{m′} calculation unit 5 divides Cₙ by M, provides the integer part C_{m′} of the result to the Cm calculation unit 7 as Cₘ_{_{—}}temp and provides the remainder (mod (Cₙ/M)) to the ΣC_{nD} calculation unit 6 as C_{nD}.

The ΣC_{nD} calculation unit 6 performs summation processing of C_{nD} and outputs ΣC_{nD} for every frame. However, when the summation value of C_{nD} becomes greater than or equal to M, the ΣC_{nD} calculation unit 6 subtracts M from the summation value and outputs the result as ΣC_{nD} while at the same time provides a +1 request signal to the Cₘ calculation unit 7.

The Cₘ calculation unit 7 receives Cₘ_{_{—}}temp (C_{m′}) and, if receiving the +1 request signal from the ΣC_{nD} calculation unit 6 in the frame period, adds 1 to Cₘ_{_{—}}temp and outputs the result as Cₘ. When there is not a +1 request signal, the Cₘ calculation unit 7 outputs Cₘ_{_{—}}temp as Cₘ. Cₘ output from the Cₘ calculation unit 7 is treated as the final Cₘ to be transmitted to the receiving end (demapping end) of the frame.

While the amount of data in each frame or the cumulative value (summation value) of amounts of data added over a predetermined number N of cycles that is a function of M is obtained as Cₙ (Cₙ(t)) in this embodiment, the amount of data in each frame may be added a given number of cycles to obtain a cumulative value (summation value) and the cumulative value may be converted to a cumulative value (summation value) of M additions.

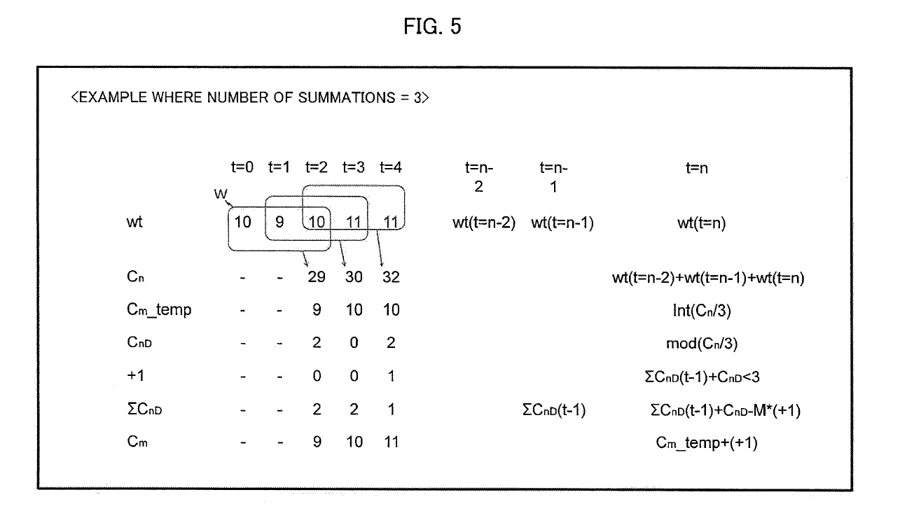

FIG. 5 illustrates changes in the GMP parameters with time when the number of additions (summations) is 3. As illustrated in FIG. 5, the Cₙ calculation unit 4 has a summation window W having a size dependent on the number of summations and adds the amount of data in every frame period in the summation window W, where the last amount of data is the current amount of data, to derive Cₙ.

Data stored in the plurality of buffers 2 in one frame period is mapped into the payload area of a server frame corresponding to that period and stuffs are placed as needed. On the other hand, Cₘ and ΣC_{nD} are placed in predetermined bytes in the OH of the server frame (for example JC (Justification Control) bytes) as information used in demapping. In the specification of G.709 relating to GMP, Cₘ is placed in JC1 and JC2 bytes and ΣC_{nD} is placed in JC4 and JC5 bytes.

After monitoring and control information, for example, is added to the OH of the server frame or after a plurality of server frames are multiplexed and then monitoring and control information is added, the server frames are converted to an optical signal, arrives at a specified receiving end through an optical network, and demapping is performed at the receiving end. The receiving end uses Cₘ and ΣC_{nD} contained in the OH in the demapping.

According to the exemplary configuration and operation of the data derivation apparatus 1 described above, a client signal is parallelized with an M-byte granularity and the parallelized data series are temporarily stored in the buffers 2. The counter 3 derives the amount of data stored in any of the buffers 2 in each server frame period. The Cₙ calculation unit 4 sums up the amounts of data in M server frame periods to derive Cₙ (an approximate value of Cₙ). Since the sum of the amounts of data in M server frame periods is used as Cₙ, Cₘ and ΣC_{nD} based on correct Cₙ can be transmitted to the receiving end.

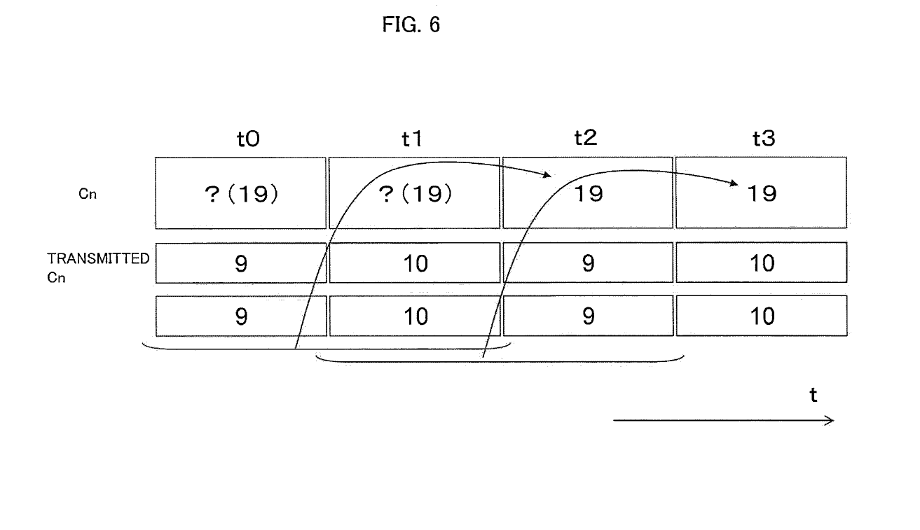

FIG. 6 is a diagram illustrating an operation relating to the configuration of the first embodiment. For the sake of simplicity, the number of parallel data series M=2 in FIG. 6. It is assumed that the average bit rate of Cₙ is 19 as illustrated in FIG. 6. In order to make the amounts of data in the parallel data series equal when the two parallel data series are transmitted, one may contemplate alternatively placing a server frame period in which Cₙ is calculated as 9 ×2 (see frames t0 and t2) and a server frame period in which Cₙ is calculated as 10×2 (see frames t1 and t3).

Here, Cₙ=18 can be obtained from the data amount 9 of one of the parallel data series in server frame period t0 (t2) and the number of parallel data series, 2. Similarly, Cₙ=20 in server frame period t1 (t3) can be obtained. However, neither of them is equal to the proper value of Cₙ, 19. Furthermore, the fact that Cₙ changes from server frame period to server frame period is equivalent to that the client frequency varies from server frame period to server frame period. Consequently, the receiving end (demapping end) may need a circuitry design by taking into consideration jitter components and frequency deviations.

In contrast, the configuration of the first embodiment enables the proper value of Cₙ, 19, to be obtained in server frame period t2 and the constant Cₙ value of 19 to be derived in the subsequent server frame periods. Accordingly, server frames containing Cₘ and ΣC_{nD} based on accurate Cₙ can be transmitted. Furthermore, the configuration of the first embodiment can avoid increase of complexity of the circuitry configuration at the receiving end.

As can be seen from the comparison between FIGS. 1 and 4, only the Cₙ calculation unit 4 is added as the component for calculating Cₙ, beside the components relating to parallelization of client signals (the plurality of buffers 2). According to the first embodiment, correct Cₙ can be obtained with a simple configuration.

A configuration has been described in which the amount of data in a frame period is obtained on the basis of write enable signals or write clock signals in the first embodiment. Instead of the configuration, a configuration may be used in which the capacity of the buffers 2 are monitored and the amounts of data in the buffers 2 are obtained from variations in the buffer capacity (initial value+amount of data written−amount of data read) in server frame period. Thus, according to the embodiment is capable of deriving a correct amount of data to be mapped into a frame.

### Second Embodiment

A data amount derivation apparatus according to a second embodiment of the present invention will be described. The second embodiment includes elements in common with the first embodiment. The description of the elements common to the embodiments will be omitted and differences from the first embodiment will be primarily described. The same components described in the second embodiment as those of the first embodiment are given the same reference signs.

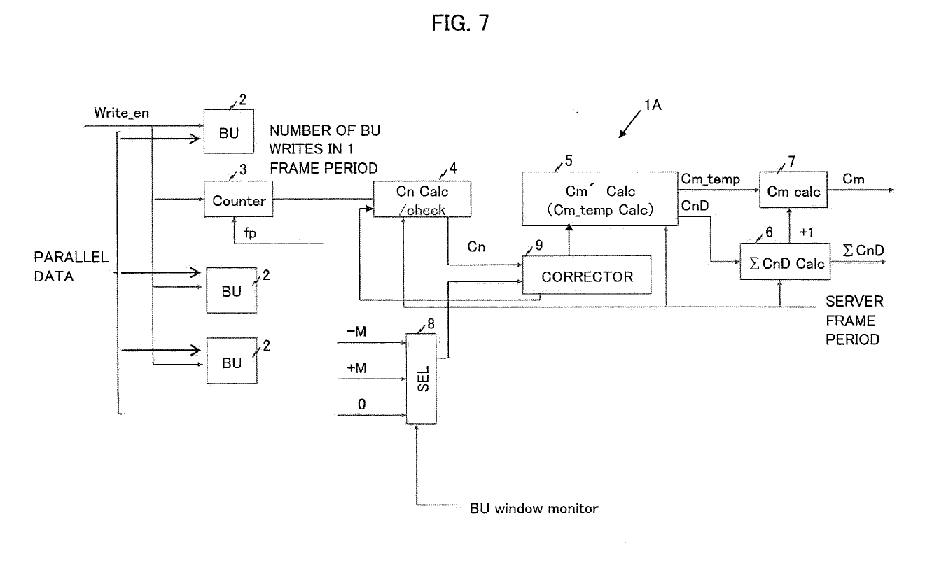

FIG. 7 is a diagram illustrating an exemplary configuration of a data amount derivation apparatus 1A according to the second embodiment. The data amount derivation apparatus 1A differs from the data amount derivation apparatus 1 according to the first embodiment (FIG. 4) in the inclusion of a selector 8 and a correction unit (corrector) 9.

The selector 8 couples a signal indicating one of “−M”, “+M” and “0” to the correction unit 9 in accordance with a control signal from a BU window monitor, not depicted, for the buffers 2. The BU window monitor monitors the capacity of one of a plurality of buffers 2 and provides a control signal to the selector 8 in every server frame period. When the amount of data held in the buffer 2 (buffered amount) is less than or equal to a first threshold that indicates the buffered amount has approached underflow, the BU window monitor provides a control signal to the selector 8 to cause the selector 8 to output “−M”. When the buffered amount is greater than or equal to a second threshold that indicates that the buffered amount has approached overflow, the BU window monitor provides a control signal to the selector 8 to cause the selector 8 to output “+M”. When the buffered amount is greater than the first threshold and less than the second threshold, the BU window monitor provides a control signal to the selector 8 to cause the selector 8 to output “0”.

A Cₙ calculation unit 4 provides the value of Cₙ derived in the same way as in the first embodiment to the correction unit 9, instead of the C_{m′} calculation unit (Cₘ_{_{—}}temp Calc) 5. The correction unit 9 corrects the value of Cₙ from the Cₙ calculation unit 4 with a signal output from the selector 8 (one of “−M”, “+M” and “0”) and provides the corrected Cₙ to a C_{m′} calculation unit 5 while at the same time feeds back the corrected Cₙ to the Cₙ calculation unit (Cₙ_{_{—}}calc/check) 4. The fed-back Cₙ is used by the Cₙ calculation unit 4 to derive Cₙ in the next server frame period. The C_{m′} calculation unit 5, the ΣC_{nD} calculation unit 6, and the Cₘ calculation unit 7 perform the same processes as in the first embodiment.

The second embodiment has the same advantageous effects as the first embodiment. In addition, the second embodiment has the following advantageous effect. In both of the first and second embodiments, Cₙ is determined after the amounts of data in M server frame periods have been counted. Accordingly, Cₙ mildly changes with frequency deviations (variations in the frequency of a client signal). When Cₙ does not sufficiently changes with actual variations in frequency deviations (Cₙ becomes less than or equal to the first threshold (there is a high probability of underflow)) or becomes greater than or equal to the second threshold (there is a high probability of overflow), the amount of data equivalent to M is added to or subtracted from the value of Cₙ obtained by the Cₙ calculation unit 4 so that the value of Cₙ can be made closer to the frequency deviation. Consequently, server frames containing Cₘ and ΣC_{nD} based on a correct value of Cₙ as compared with the first embodiment can be transmitted.

### Third Embodiment

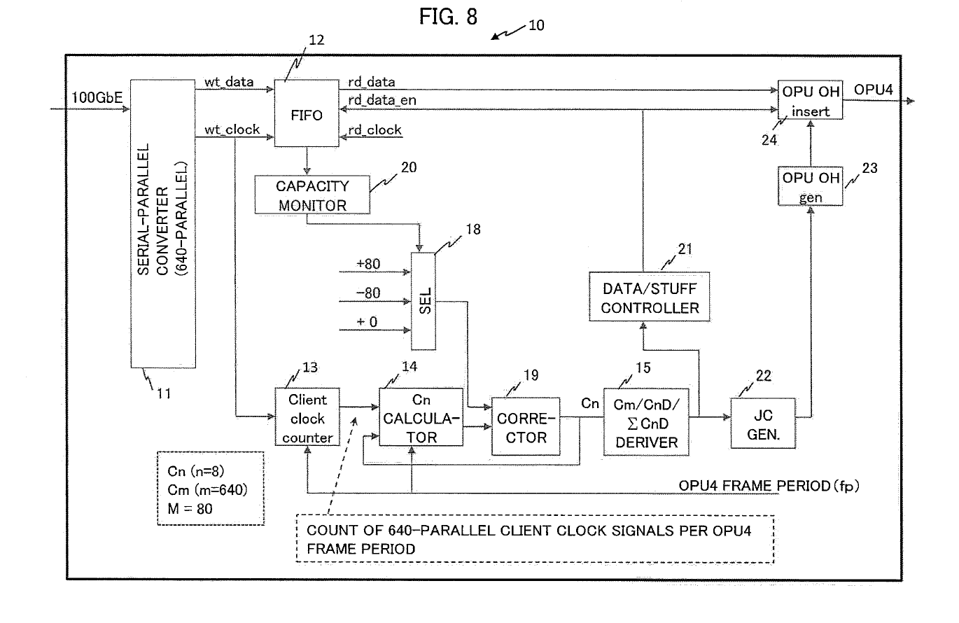

An embodiment of a GMP mapping apparatus will be described as a third embodiment. FIG. 8 illustrates an exemplary configuration of a GMP mapping apparatus (OPU frame generation apparatus) that maps client signals (Ethernet signals) into server frames.

In the example illustrated in FIG. 8, the GMP mapping apparatus 10 (hereinafter simply referred to as the mapping apparatus 10) maps a client signal, which is 100 GbE, into an OPU4 frame, which is a server frame. In the example illustrated in FIG. 8, Cₙ (n=8) and Cₘ (m=640), and M is 80.

In FIG. 8, a serial-parallel converter 11 converts a 100 GBE client signal input into the mapping apparatus 10 to 640 parallel data series.

Then, each of the parallel data series is written into a FIFO (First-In First-Out) memory 12, which is a buffer memory used for placing a client signal into the payload area of a server frame as write data (wt_data) in order to accomplish clock transfer from a client clock (client frequency) to an OPU clock. While only one FIFO memory 12 is depicted in FIG. 8, as many FIFO memories 12 as the number of parallel data series are provided.

A write clock signal (wt_clock: 1/640 frequency divided clock signal) for a data write into the FIFO memory 12 is input from the serial-parallel converter 11. The write clock signal is also input into a counter (client clock counter) 13.

The counter 13 takes input of a signal (fp) indicating a frame period of OPU4 and counts the number of write clock signals during a server frame period. The counter 13 inputs the number of write clock signals in each server frame (which is equivalent to the amount of data in each server frame) to a Cₙ calculation unit.

The Cₙ calculation unit 14 is equivalent to the Cₙ calculation unit 4 and has the function equivalent to that of the Cₙ calculation unit 4. That is, the Cₙ calculation unit 14 adds the numbers of write clock signals, each number being input from the counter 13 in each frame period, over 80 server frame periods (M=80) and provides the obtained sum as provisional Cₙ. The Cₙ calculation unit 14 may have a summation window (see FIG. 5) for the summation of the amounts of data in 80 frame periods, including the current frame period. Like the Cₙ calculation unit 4, the Cₙ calculation unit 14 checks to see whether the provisional Cₙ is in a valid range or not and provides the provisional Cₙ to a correction unit (corrector) 19.

A capacity monitor 20 monitors the amount of data held in the FIFO memory 12 (buffered amount). An underflow alarm threshold (first threshold) indicating that the buffered amount has approached underflow and an overflow alarm threshold (second threshold) indicating that the buffered amount has approached overflow are set in the FIFO memory 12.

The capacity monitor 20 outputs a control signal that is dependent on the buffered amount for a selector (SEL) 18. In particular, when the buffered amount is less than or equal to the first threshold, the capacity monitor 20 provides a control signal for the selector 18 to output “−80” to the selector 18. When the buffered amount is greater than the first threshold and less than the second threshold, the capacity monitor 20 provides a control signal for the selector 18 to output “0” to the selector 18. When the buffered amount is less than or equal to the second threshold, the capacity monitor 20 provides a control signal for the selector 18 to output “+80” to the selector 18. The signal, “−80”, “+80” or “0” output from the selector 18 is input into the correction unit 19.

When the correction unit 19 receives the “−80” signal, the correction unit 19 subtracts 80 from the provisional Cₙ input from the Cₙ calculation unit 14 and outputs the resulting value as the final value of Cₙ. When the correction unit 19 receives the “+80” signal, the correction unit 19 adds 80 to the provisional value Cₙ and outputs the sum as the final value of Cₙ. When the correction unit 19 receives the “0” signal, the correction unit 19 outputs the provisional Cₙ as the final Cₙ. Cₙ output from the correction unit 19 is input into a Cₘ/C_{nD}/ΣC_{nD} derivation unit (deriver) 15 while at the same time is fed back to the Cₙ calculation unit 14. The fed-back Cₙ is used by the Cₙ calculation unit 14 for deriving Cₙ in the next frame period.

The Cₘ/C_{nD}/ΣC_{nD} derivation unit 15 has the same functions as the C_{m′} calculation unit 5, the ΣC_{nD} calculation unit 6 and the Cₘ calculation unit 7 described in the first and second embodiments. The Cₘ/C_{nd}/ΣC_{nD} derivation unit 15 outputs the final Cₘ and ΣC_{nD} to a data/stuff control unit (controller) 21 and JC generation unit (generator) 22.

The data/stuff control unit 21 (hereinafter referred as the control unit 21) controls the timing of outputting a read enable signal (rd_data_en) to the FIFO memory 12 on the basis of the payload capacity of OPU4 and the final Cₘ (actual amount of transmission data). In particular, the control unit 21 determines the mapping locations of the amount Cₘ of data in such a manner that stuffs are evenly mapped in the payload area of an OPU4 frame and outputs a read enable signal so that the data from the FIFO memories 12 are placed (stored) in the mapping locations.

While the read enable signal is being input, data is read from the FIFO memories 12 which have received the read enable signal in accordance with a read clock signal (rd_clock) and is sent to an OPU overhead insertion unit (OPU OH insert) 24.

The JC generation unit 22 generates JC bytes (JC1 and JC2 bytes) including Cₘ and JC bytes (JC4 and JC5 bytes) including ΣC_{nD} and provides the bytes to an OPU overhead generation unit (OPU OH gen) 23.

The OPU overhead generation unit 23 generates an overhead (OH) of an OPU4 frame and provides the OH to the OPU overhead insertion unit 24. The OH generated here contains the JC bytes including Cₘ and ΣC_{nD} (JC1, JC2, JC4 and JC5) mentioned above. The OPU overhead insertion unit 24 adds the OH to the payload area into which data and stuff are mapped and sends out the result as an OPU4 frame.

According to the third embodiment, the GMP mapping apparatus (OPU frame generation apparatus) has the same advantageous effects as the first and second embodiments. In addition, the GMP mapping apparatus is capable of transmitting OPU4 frames including correct Cₘ and ΣC_{nD}.

### <Variation or Modification>

The following variation or modification of the third embodiment described above is possible. In the third embodiment, 100 GbE is converted to 640 parallel data series based on an 80-byte granularity and the Cₙ calculation unit 14 sums up the amounts of data in 80 frame periods to obtain Cₙ. However, a signal may be converted to any determined number of parallel data series and the amounts of data may be added (summed up) over any determined number of frame periods.

Furthermore, Cₙ correction based on monitoring the capacity of the FIFO memories 12 in the third embodiment uses addition or subtraction of “+80” or “−80” to or from Cₙ because the granularity is 80 bytes. However, this is illustrative only and any appropriate amount of correction can be applied.

### <<Other Methods for Deriving Cₙ>>

Cₙ can be obtained as described below. In particular, Cₙ can be obtained according to the following equation:

$$\begin{matrix}{C}_{n} = ( sum of N additions \times M / N / ( M * 8 ) / L ) \\ = ( sum of N additions / N / 8 \times L )\end{matrix}$$

where L is the number of parallel data series converted from a client signal with an M-byte granularity and N is the number of additions.
The number of additions N can be obtained as follows:
(1) M=N fixed (a first method)
(2) The capacities of the FIFO 12 are monitored and the frequency of changes in the amount of data in the FIFO (buffered amount) is reflected in N. That is, N is changed according to the buffered amount (a second method). That is, N is changed in accordance with the buffered amount. The second method includes first and second methods for changing the N value.

### (2-1) First Method for Changing N Value

For the buffers 12, the region between the first and second thresholds, inclusive, described above is set as a Cₙ value change range (correction execution range). The Cₙ calculation unit 14 receives the buffered amount in the buffers 12 from the capacity monitor 20 in each frame period.

When the buffered amount has reached the Cₙ value change range, the Cₙ calculation unit 14 subtracts 1 from the current value of N (N=N−1) (the condition for subtraction). On the other hand, when the buffered amount has not reached the Cₙ value change range, the Cₙ calculation unit 14 counts the number of frame periods during the time in which the range has not been reached. When subsequently the number of frame periods during the time in which the range has not been reached reaches N, the Cₙ calculation unit 14 adds 1 to the current value of N (N=N+1) (the condition for addition). That is, when the buffered amount has not reached the Cₙ value change range for the N frame periods, 1 is added to N.

At least one of the upper and lower limits to the value N may be preset and once N reaches the upper or lower value, the Cₙ calculation unit 14 may retain the value of N even when the condition for subtraction or addition to or from N described above is satisfied.

### (2-2) Second Method for Changing Value of N

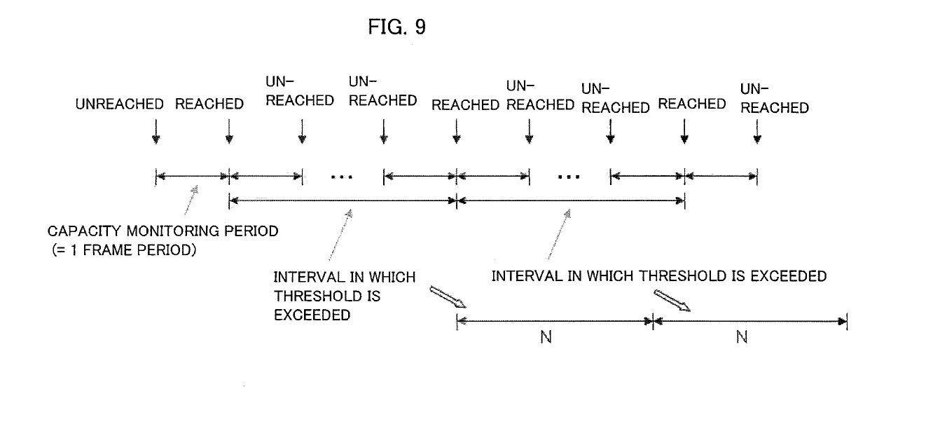

The number of frame periods between the previous reaching of the Cₙ value change range and the current reaching of the Cₙ value change range is set to N. That is, as illustrated in FIG. 9, when the buffered amount reaches the Cₙ value change range in a frame period, the Cₙ calculation unit 14 starts counting the number of frame periods from that frame period. When the buffered amount reaches the Cₙ value change range again, the Cₙ calculation unit 14 determines as N the number of frame periods between the previous reaching of the Cₙ value change range and the current reaching of the Cₙ value change range.

M can be used as the initial value of N when one of the first and second methods for changing N is used.

<<Mapping into ODPU Frames>>

An example of first type GMP mapping in which a client signal is mapped into OPU4 frames equivalent to LO OPUj frames has been described in the third embodiment.

The configuration described in the third embodiment can be applied to mapping LO ODUj frames converted from a client signal into ODTU frames using GMP (GMP of the second type).

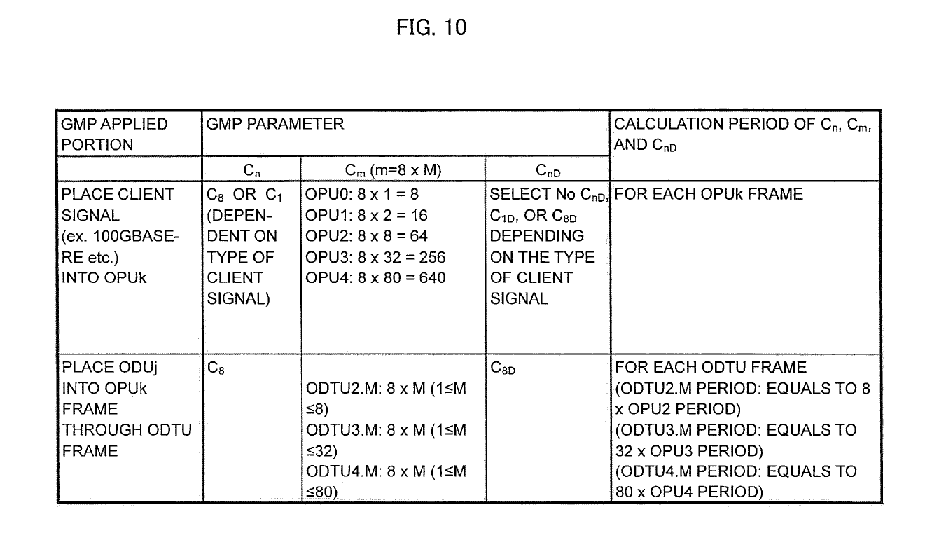

FIG. 10 is a table illustrating GMP applied portions, GMP parameters, and periods in which Cₙ, Cₘ and C_{nD} are calculated. The upper row of the table illustrates the first type of GMP and the lower row illustrates the second type. In the second type, GMP parameters Cₙ, Cₘ and C_{nD} are calculated at every ODTU frame period. ODTU frame periods and OPUk frame periods are related to each other. For example, the ODTU4.ts frame period is equal to 80×OPU4 frame period.

Accordingly, if a client signal is LO ODU0, for example, and is mapped into an ODTU4.1 frame, the values of Cₙ, Cₘ, and M are Cₙ (n=8), Cₘ (m=8) and M=1, respectively. The serial-parallel converter 11 divides the LO ODU0 signal into eight and the write clock signal (wt_clock) is a 1/8 frequency divided clock signal. The server frame period input into the counter 13 and the Cₙ calculation unit 14 is an ODTU4.1 frame period, that is, OPU4 frame period×80. These modifications enable mapping of an LO ODUj frame into an ODTU frame.

In this way, the configuration of the third embodiment can be applied to a combination of an LO ODUj frame and an ODTU frame in the method of second type by changing the number of parallel data series and the length of a frame period in response to variations in the values of Cₙ, Cₘ, and M according to the LO ODUj signal to be mapped and the ODTU frame into which the signal is to be mapped.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data amount derivation apparatus, comprising:
a first calculator configured to derive, for one series of parallelized mapping signals, amount of data in each frame period for a frame into which the parallelized mapping signals are mapped; and
a second calculator configured to sum up amounts of data in N frame periods, where N is an integer, and to derive the resulting summation value as the amount of data to be mapped into the frame, each of the amounts of data in each of the frame periods being derived by the first calculator.

2. A data amount derivation apparatus, comprising:
a first calculator configured to derive, for one series of parallelized mapping signals, amount of data in each frame period for a frame into which the mapping signals are mapped, the parallelized mapping signals being parallelized into a number L of series with an M-byte granularity, where each of L and M is an integer; and
a second calculator configured to sum up the amounts of data in N frame periods to derive a summation value, where N is an integer, dividing the summation value by the N, and dividing the resulting value by (8×L) to derive the amount of data to be mapped into the frame, each of the amounts of data in each of the frame periods being derived by the first calculator.

3. The data amount derivation apparatus according to claim 1,
wherein the parallelized mapping signals are parallelized with an M-byte granularity, where M is an integer; and
the second calculator derives the summation value using the M as the number N of frame periods.

4. The data amount derivation apparatus according to claim 1, further comprising:
a buffer configured to temporarily hold one series of the parallelized mapping signals; and
a corrector configured to correct the amount of data to be mapped into the frame derived by the second calculator in accordance with the amount of data of the mapping signal in each frame period held in the buffer.

5. The data amount derivation apparatus according to claim 4, wherein the correction unit subtracts a predetermined amount of data from the amount of data to be mapped into the frame derived by the second calculator when the amount of data held in the buffer is less than or equal to a first threshold warning of underflow of the buffer, and adds a predetermined amount of data to the amount of data to be mapped into the frame derived by the second calculator when the amount of data held in the buffer is greater than or equal to a second threshold warning of overflow of the buffer.

6. The data amount derivation apparatus according to claim 1, wherein:
the corrector performs the correction when the amount of data held in the buffer reaches a correction execution range; and
the second calculator changes the value of N in accordance with the frequency of the amount of data held in the buffer reaching the correction execution range.

7. The data amount derivation apparatus according to claim 6, wherein the second calculator subtracts 1 from the current value of N each time the amount of data held in the buffer reaches the correction execution range.

8. The data amount derivation apparatus according to claim 6, wherein the second calculator adds 1 to the current value of N when N consecutive frame periods in which the amount of data held in the buffer has not reached the correction execution range have been encountered.

9. The data amount derivation apparatus according to claim 6, wherein:
the value of N has at least one of upper limit and lower limit; and
the second calculator retains the current value of N once the value of N has reached at least one of the upper limit and the lower limit, even if a condition for changing the value of N is satisfied.

10. The data amount derivation apparatus according to claim 6, wherein the second calculator sets as the value of N the number of frame periods between the previous reaching of the correction execution range by the amount of data held in the buffer and the current reaching of the correction execution range by the amount of data held in the buffer.

11. The data amount derivation apparatus according to claim 1, further comprising:
a third calculator configured to derive a second amount of data actually mapped into the frame, wherein a first amount of data is defined as the amount of data to be mapped into the frame;
a fourth calculator configured to derive a difference between the first amount of data and the second amount of data;
a fifth calculator configured to derive a cumulative value of the differences over frames; and
an adjuster configured to add, when the cumulative value exceeds a predetermined amount, the predetermined amount to the second amount of data and to subtract a predetermined amount from the cumulative value.

12. The data amount derivation apparatus according to claim 1, wherein the frame conforms to an Optical Transport Network standard and the amount of data to be mapped into the frame is a logical value Cₙ used in Generic Mapping Procedure.

13. A frame generation apparatus, comprising:
a buffer configured to hold parallelized mapping signals to be mapped into frames;
a first calculator configured to derive amount of data in each frame for one series of the parallelized mapping signals held in the buffer;
a second calculator configured to sum up amounts of data in N frame periods, where N is an integer, and to derive the resulting summation value as the amount of data to be mapped into the frame, each of the amounts of data in each of the frame periods being derived by the first calculator;
a third calculator configured to derive a second amount of data actually mapped into the frame, wherein a first amount of data is defined as the amount of data to be mapped into the frame;
a fourth calculator configured to derive a difference between the first amount of data and the second amount of data;
a fifth calculator configured to derive a cumulative value of the differences over frames; and
an adjuster configured to add, when the cumulative value exceeds a predetermined amount, the predetermined amount to the second amount of data and to subtract a predetermined amount from the cumulative value;
a controller configured to control, based on the second amount of data, mapping of parallelized mapping signals held in the buffer into a payload area of the frame;
a generator configured to generate an overhead for the frame, the overhead including the difference and the cumulative value; and
a transmitter configured to transmit the frame including the payload area containing parallelized mapping signals having the second amount of data, the frame having the overhead generated by the generation unit added.

14. A frame generation apparatus, comprising:
a first calculator configured to derive, for one series of parallelized mapping signals, amount of data in each frame period for a frame into which the mapping signals are mapped, the parallelized mapping signals being parallelized into a number L of series with an M-byte granularity, where each of L and M is an integer;
a second calculator configured to sum up amounts of data in N frame periods to derive a summation value, where N is an integer, to divide the summation value by the N, and to divide the resulting value by (8×L) to derive the amount of data to be mapped into the frame, each of the amounts of data in each of the frame periods being derived by the first calculator;
a third calculator configured to derive a second amount of data actually mapped into the frame, wherein a first amount of data is defined as the amount of data to be mapped into the frame;
a fourth calculator configured to derive a difference between the first amount of data and the second amount of data;
a fifth calculator configured to derive a cumulative value of the differences over frames; and
an adjuster configured to add, when the cumulative value exceeds a predetermined amount, the predetermined amount to the second amount of data and to subtract a predetermined amount from the cumulative value;
a controller configured to control, based on the second amount of data, mapping of parallelized mapping signals held in the buffer into a payload area of the frame;
a generator configured to generate an overhead for the frame, the overhead including the difference and the cumulative value; and
a transmitter configured to transmit the frame including the payload area containing parallelized mapping signals having the second amount of data, the frame having the overhead generated by the generation unit added.

15. A method for deriving data, comprising:
deriving, for one series of parallelized mapping signals, amount of data in each frame period for a frame into which the parallelized mapping signals are mapped; and
summing up amounts of data in N frame periods, each of the amounts of data being in each of the N frame periods where N is an integer, and deriving the resulting summation value as the amount of data to be mapped into the frame.

16. A method for deriving data, comprising:
for one series of parallelized mapping signals, deriving amount of data in each frame period for a frame into which the mapping signals are mapped, the parallelized mapping signals being parallelized into a number L of series with an M-byte granularity, where each of L and M is an integer; and
summing up amounts of data in N frame periods to derive a summation value, each of the amounts of data being in each of the N frame periods where N is an integer, dividing the summation value by the N, and dividing the resulting value by (8×L) to derive the amount of data to be mapped into the frame.
